(19) United States
(12) Patent Application Publication
(10) Pub. No.: US 2018/0107312 A1
(43) Pub. Date: Apr. 19, 2018

(54) ANTI-SCATTERING FILM AND MANUFACTURING METHOD THEREOF, TOUCH SCREEN AND DISPLAY DEVICE

(71) Applicants: BOE Technology Group Co., Ltd., Beijing (CN); Hefei Xinsheng Optoelectronics Technology Co., Ltd., Anhui (CN)

(72) Inventors: Jing Wang, Beijing (CN); Dong Li, Beijing (CN); Yuzhao Zhang, Beijing (CN); Xiaodong Xie, Beijing (CN); Min He, Beijing (CN)

(73) Assignees: BOE Technology Group Co.,Ltd., Beijing (CN); Hefei Xinsheng Optoelectronics Technology Co., Ltd., Anhui (CN)

(21) Appl. No.: 15/520,996

(22) PCT Filed: Jun. 24, 2016
(86) PCT No.: PCT/CN2016/087030

§ 371 Date: Apr. 21, 2017

(30) Foreign Application Priority Data
Mar. 4, 2016 (CN) 201610126023.6

(51) Int. Cl. G06F 3/041; G02B 1/10

(52) U.S. Cl. CPC G06F 3/0412; G06F 2203/04103; G02B 1/10

(57) ABSTRACT

The present disclosure provides an anti-scattering film and a manufacturing method thereof, a touch screen and a display device. The anti-scattering film includes a transparent substrate. The transparent substrate includes a central region and a peripheral region around the central region, and a light-shielding layer is provided in the peripheral region.

### CROSS-REFERENCE TO RELATED APPLICATION

This application is a Section 371 National Stage Application of International Application No. PCT/CN2016/087030, filed on Jun, 24, 2016, entitled “ANTI-SCATTERING FILM AND MANUFACTURING METHOD THEREOF, TOUCH SCREEN AND DISPLAY DEVICE”, which has not yet published, which claims priority to Chinese Application No. 201610126023.6, filed on Mar. 4, 2016, incorporated herein by reference in their entirety.

### BACKGROUND OF THE DISCLOSURE

### Field of the Disclosure

The present disclosure relates to a technical field of display, more particularly, to an anti-scattering film and a manufacturing method thereof, a touch screen and a display device.

### Description of the Related Art

A traditional capacitive touch panel generally has a structure (i.e. CG structure) obtained by bonding a layer of cover glass with a layer of touch glass with an optical adhesive (for example, OCA). However, with increasing demands such as light, thin and low-cost touch panel in the market, the GG structure has not met these demands and has been gradually replaced by other touch structures such as GF, GFF, OGS and the like. Compared with the traditional structure, the OGS structure has several advantages, such as simple structure, thin and thin characteristics, good transparency, low manufacturing cost, etc. so that its prospect is kept optimistic in the market.

Currently, a touch panel (abbreviated as TP) and a liquid crystal display module (abbreviated as LCD module or LCM) in the OGS structure are mainly bonded in manners of full lamination or edge lamination. In the full lamination, the touch panel and the LCM are bonded by bonding their entire surfaces with an optical adhesive (for example, OCA or OCR). In the edge lamination, the touch panel and the LCM are bonded by bonding their edges with an edge-laminating adhesive (also referred to as square adhesive). As the full lamination has a high cost and a poor rework characteristic, a market share of the edge lamination product is higher than that of the full lamination product in the current market. In the edge lamination, a layer of anti-scattering film is generally attached on the touch panel to effectively prevent fragments of broken glass panel due to an accidental impact on the product from scattering, thereby not only reducing invisible injuries caused by the glass panel so as to protect user security but also maintaining unique luster and texture of a reinforced glass and increasing a surface hardness.

However, in the current market, the touch panel with the OGS structure has encountered problems in appearance compared with the touch panel having the GG, GF and GFF structures. In the conventional GG, GF and GFF structures, black ink or white ink is used as a frame material of a cover plate so that a black touch panel or a white touch panel may be manufactured. In the OGS structure, a photoresist is used as the frame material. However, the white resist is not yet mature in the current market. In order to make the glass cover plate having the white resist obtain the same optical effect as the cover plate having the white ink, a thickness of the white resist is required to reach at least 15 μm and the white resist is additionally coated with an additional layer of black resist having a thickness of 1˜2 μm. As a result, it is possible to break signal lines (formed of ITO or metal material) on the cover plate as the signal lines extend across the different thicknesses, thereby causing a functional failure.

### SUMMARY

Embodiments of the present disclosure aim to provide an anti-scattering film and a manufacturing method thereof, a touch screen and a display device, which are capable of reducing a possibility of the breakage of the signal lines as the signal lines extend across the different thicknesses in the OGS touch panel.

As such, a solution of the present disclosure provides an anti-scattering film comprising a transparent substrate, wherein, the transparent substrate comprises a central region and a peripheral region around the central region, and a light-shielding layer is provided in the peripheral region.

Optionally, a material of the light-shielding layer comprises any one of white ink and black ink.

Optionally, a transparent filler layer is further provided on the transparent substrate provided with the light-shielding layer, and the transparent filler layer and the light-shielding layer are located on the same side of the transparent substrate, and
wherein, an adhesive layer is further provided on a side of the transparent filler layer away from the transparent substrate.

Optionally, the transparent filler layer covers both the central region of the transparent substrate and the light-shielding layer, and a thickness of a portion of the transparent filler layer covering the central region of the transparent substrate is greater than a thickness of a portion of the transparent filler layer covering the light-shielding layer.

Optionally, the transparent filler layer only covers the central region of the transparent substrate, and a thickness of the transparent filler layer is equal to a thickness of the light-shielding layer.

Optionally, a protective layer is provided on a side of the transparent substrate away from the light-shielding layer, and a release film is provided on a side of the adhesive layer away from the transparent filler layer.

In order to solve the above problem, the present disclosure may further provide a touch screen comprising a touch panel, wherein, the touch panel is provided with the anti-scattering film described above.

Optionally, the touch panel comprises a photoresist frame, and a projection of the light-shielding layer onto the transparent substrate is within a projection of the photoresist frame onto the transparent substrate.

Optionally, the photoresist frame has the same pattern as the light-shielding layer.

Optionally, the touch panel further comprises an alignment mark, and the alignment mark is formed of the same material and provided on the same layer as the photoresist frame.

In order to solve the above problem, the present disclosure may further provide a display device comprising the touch screen described above.

In order to solve the above problem, the present disclosure may further provide a manufacturing method of an anti-scattering film comprising steps of:
providing a transparent substrate; and
forming a light-shielding layer in a peripheral region of the transparent substrate.

Optionally, after the step of forming the light-shielding layer in the peripheral region of the transparent substrate, the manufacturing method further comprises steps of:
forming a transparent filler layer on the transparent substrate, the transparent filler layer and the light-shielding layer being located on the same side of the transparent substrate; and
forming an adhesive layer on a side of the transparent filler layer away from the transparent substrate.

Optionally, the light-shielding layer is formed of white ink or black ink.

### BRIEF DESCRIPTION OF THE DRAWINGS

FIG. 1 is a schematic sectional view of an anti-scattering film according to an embodiment of the present disclosure;

FIG. 2 is a top view of the anti-scattering film in FIG. 1;

FIG. 3 is a schematic sectional view of an anti-scattering film according to another embodiment of the present disclosure; and

FIG. 4 is a schematic view of a display device according to an embodiment of the present disclosure.

### DETAINED DESCRIPTION OF PREFERRED EMBODIMENTS OF THE DISCLOSURE

The specific implementations of the present disclosure will be further described in detail in combination with the following embodiments and the accompanying drawings. The following embodiments are used to merely explain the present disclosure, but are not intended to limit the scope of the present disclosure.

An embodiment of the present disclosure provides an anti-scattering film comprising a transparent substrate. The transparent substrate comprises a central region and a peripheral region around the central region. A light-shielding layer is provided in the peripheral region.

The anti-scattering film according to the embodiment of the present disclosure may be used in the OGS touch panel. As the peripheral region of the transparent substrate is additionally provided with a light-shielding layer which is capable of improving an optical effect of the touch panel, a thickness of a photoresist frame in the touch panel may be reduced and the photoresist frame in the touch panel may even be omitted, so as to reduce the possibility of the breakage of the signal lines as the signal lines extend across the different thicknesses in the OGS touch panel.

In an example, a material of the light-shielding layer in the above anti-scattering film may comprise an ink. Ink may be printed in the peripheral region of the transparent substrate through a screen printing process so as to form a desired light-shielding layer. For example, with regard to a white OGS touch panel, the material of the light-shielding layer in the anti-scattering film may comprise a white ink. With regard to a black OGS touch panel, the material of the light-shielding layer in the anti-scattering film may comprise a black ink.

Moreover, in an existing manufacturing process of the OGS touch panel, it is required to reserve an allowance of several hundred microns for secondary printing and chamfer grinding when the manufactured touch mother plate is cut into single touch panel. During the secondary printing, ink, a curing agent and a diluent are prepared and stirred completely and evenly, a surface of the touch panel is cleaned, and a screen with a suitable mesh is selected to perform the secondary printing. However, when the secondary printing is performed in the above manner, as there is a difference in thickness between the printed ink and the photoresist material, not only several defects including undesirable jagged edges, light leakage and the like are presented in the final product so that a color difference and a poor appearance occurs in an appearance of the OGS product, thereby affecting the product quality, but also a large dose of ink is wasted during the manufacturing process. With the above anti-scattering film according to the embodiment of the present disclosure, the secondary printing process is not needed so as to avoid the jagged ink edges and light leakage due to the difference in thickness between the printed ink and the photoresist material.

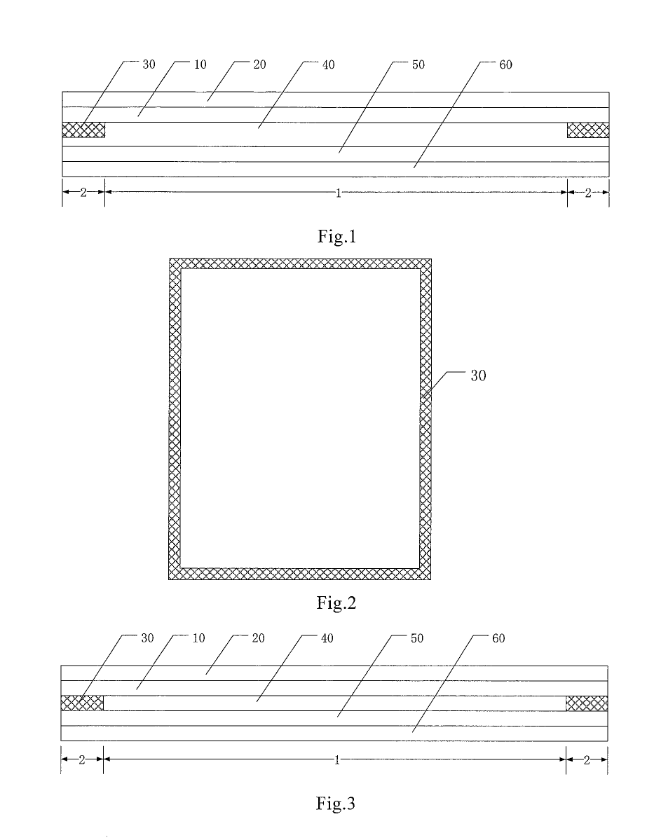

FIG. 1 is a schematic sectional view of an anti-scattering film according to an embodiment of the present disclosure, and FIG. 2 is a top view of the anti-scattering film. As shown in FIGS. 1 and 2, the anti-scattering film may comprise a transparent substrate 10. The transparent substrate 10 may comprise a central region 1 and a peripheral region 2 around the central region 1. A light-shielding layer 30 is provided in the peripheral region 2. As shown in FIG. 1, the transparent substrate 10 is further provided with a transparent filler layer 40. The transparent filler layer 40 and the light-shielding layer 30 are positioned on the same side of the transparent substrate 10. An adhesive layer 50 is further provided on a side of the transparent filler layer 40 away from the transparent substrate 10.

In an example, the transparent substrate 10 may be formed of PET material, and the adhesive layer 50 may be formed of optical adhesive, for example, optical clear adhesive (abbreviated as OCA) or optical clear resin (abbreviated as OCR).

Optionally, the anti-scattering film according to the embodiment of the present disclosure may further comprise a protective layer 20 and a release film 60. The protective layer 20 is disposed on a side of the transparent substrate 10 away from the light-shielding layer 30. The release film 60 is disposed on a side of the adhesive layer 50 away from the transparent filler layer 40. The protective layer 20 functions to protect the transparent substrate 10 before the anti-scattering film is used. The release film 60 functions to protect the adhesive layer 50 before the anti-scattering film is used. When the anti-scattering film is used, the protective layer 20 and the release film 60 may be removed, and the adhesive layer 50 is adhered to an outer surface of a touch panel.

In an example, as shown in FIG. 1, the transparent filler layer 40 may cover both the central region 1 of the transparent substrate 10 and the light-shielding layer 30, and a thickness of the transparent filler layer 40 on the central region 1 is greater than a thickness of the light-shielding layer 30.

Moreover, the transparent filler layer 40 may cover only the central region 1, as shown in FIG. 3, and a thickness of the transparent filler layer 40 may be equal to the thickness of the light-shielding layer 30. In an example, there is neither bubble nor difference in thickness at connections between the transparent filler layer and the light-shielding layer.

For example, in the above anti-scattering film, the light-shielding layer 30 may be formed of white ink through a screen printing process so that it is applicable to the white OGS touch panel.

In an example, the anti-scattering film according to the above embodiments of the present disclosure is applicable to display products of edge lamination type (that is, the touch panel and the LCM are adhered to each other in a manner of edge lamination) or display products of full lamination (that is, the touch panel and the LCM are adhered to each other in a manner of full lamination).

The anti-scattering film according to the above embodiments of the present disclosure is applicable to white OGS touch products. By means of providing the white light-shielding layer in the peripheral region of the transparent substrate of the anti-scattering film, the light-shielding layer may improve an optical effect of the touch panel. In this way, the phenomenon such as the jagged ink edges and light leakage due to the secondary printing may be avoided, and it may effectively prevent fragments of broken glass panel from scattering. Compared with the existing process, both the product yield and the product quality may be improved, and both a lithography process and a secondary printing process for the white photoresist are saved, thereby saving cost while increasing a production line rate, reducing a manufacturing cost and shortening a production cycle.

Moreover, an embodiment of the present disclosure further provides a touch screen comprising a touch panel which is provided with the above anti-scattering film.

In an example, the touch panel may comprise a photoresist frame. A projection of the light-shielding layer on the transparent substrate is located within a projection of the photoresist frame on the transparent substrate. Optionally, the photoresist frame has the same pattern as the light-shielding layer. For example, the photoresist frame on the touch panel may be formed of black photoresist material, and the light-shielding layer of the anti-scattering film may be formed of white ink. The anti-scattering film is attached onto touch panel so as to obtain a touch panel having white OGS structure. In this way, functional defects due to the white photoresist of too large thickness for satisfying a chromaticity requirement may be avoided for the white OGS. Also, the phenomenon including the jagged ink edges and light leakage due to the secondary printing, which is required to compensate for the difference in thickness between the ink and the photoresist material, may be avoided, and it may effectively prevent fragments of broken glass panel from scattering.

Moreover, the touch panel may not be provided with the photoresist frame. In an example, with regard to black OGS products, the touch panel is not provided with the photoresist frame, and the light-shielding layer on the anti-scattering film attached onto the touch panel may achieve the same optical effect as the photoresist frame.

Optionally, in order to keep a precision for attaching the anti-scattering film onto the touch panel, the touch panel may further comprise an alignment mark to be aligned and attached with the anti-scattering film. For example, with regard to the touch panel comprising the photoresist frame, the alignment mark on the touch panel may be formed of the same material and disposed on the same layer as the photoresist frame. In other words, the alignment mark on the touch panel and the photoresist frame may be formed through a single patterning process.

An embodiment of the present disclosure may further provide a display device comprising the above touch screen or touch panel. The display device according to the embodiment of the present disclosure may include any products or components having a display function, for example, a display of a laptop computer, a display, a television, a digital frame, a cellphone, a tablet computer.

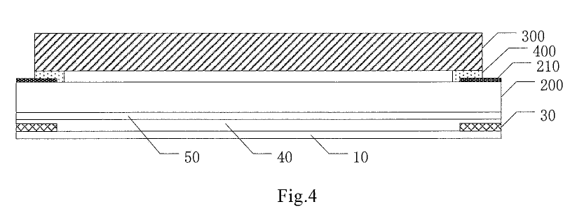

FIG. 4 is a schematic view of a display device according to an embodiment of the present disclosure. Referring to FIG. 4, the display device may comprise a liquid crystal display module (LCM) 300 and a display screen comprising a touch panel 200 and an anti-scattering film.

In an example, the LCM 300 and the display screen are adhered to each other in a manner of edge lamination. An edge-laminating adhesive 400 is provided between the LCM 300 and the display screen. The touch panel 200 is provided with a black photoresist frame 210.

The anti-scattering film is disposed on a side of the touch panel 200 away from the LCM 300. The anti-scattering film may comprise a transparent substrate 10, a light-shielding layer 30 disposed in a peripheral region of the transparent substrate 10, a transparent filler layer 40 and an adhesive layer 50. The anti-scattering film is adhered onto the touch panel 200 by means of the adhesive layer 50.

In an example, with regard to the above display device, the display device is a white touch display product if the light-shielding layer 30 on the anti-scattering film is formed of white ink, alternatively, the display device is a black touch display product if the light-shielding layer 30 is formed of black ink.

An embodiment of the present disclosure may further provide a manufacturing method of an anti-scattering film. The manufacturing method may comprise steps of:
providing a transparent substrate; and
forming a light-shielding layer in a peripheral region of the transparent substrate.

Optionally, after the step of forming a light-shielding layer in a peripheral region of the transparent substrate, the manufacturing method may further comprise steps of:
forming a transparent filler layer on the transparent substrate, the transparent filler layer and the light-shielding layer being located on the same side of the transparent substrate;
forming an adhesive layer on a side of the transparent filler layer away from the transparent substrate.

In an example, a white ink pattern required for the product to be manufactured may be firstly printed on a surface of PET material to obtain the light-shielding layer. Transparent material may be then filled into regions on the PET material without ink printing so that the transparent material has the same thickness as the white ink obtained through screen printing and there is neither bubble nor difference in thickness at connections between the transparent material and the white ink. An adhesive layer and other structures may be then formed on the PET material. After a cutting process, the anti-scattering film is adhered onto the touch panel, for example, the anti-scattering film is adhered on an outer surface of the touch panel, so as to obtain a required white OGS product.

The above embodiments are merely used to explain the present disclosure, but not to limit the present disclosure. Various changes and modifications may be made by those skilled in the art without departing from the spirit and scope of the present disclosure. Therefore, all technical equivalents are also within the scope of the present disclosure, and the scope of the present disclosure shall be defined by the appended claims.

1. An anti-scattering film comprising a transparent substrate, wherein,
the transparent substrate comprises a central region and a peripheral region around the central region, and a light-shielding layer is provided in the peripheral region.

2. The anti-scattering film according to claim 1, wherein, a material of the light-shielding layer comprises any one of white ink and black ink.

3. The anti-scattering film according to claim 1, wherein, a transparent filler layer is further provided on the transparent substrate provided with the light-shielding layer, and the transparent filler layer and the light-shielding layer are located on the same side of the transparent substrate, and
wherein, an adhesive layer is further provided on a side of the transparent filler layer away from the transparent substrate.

4. The anti-scattering film according to claim 3, wherein, the transparent filler layer covers both the central region of the transparent substrate and the light-shielding layer, and a thickness of a portion of the transparent filler layer covering the central region of the transparent substrate is greater than a thickness of a portion of the transparent filler layer covering the light-shielding layer.

5. The anti-scattering film according to claim 3, wherein, the transparent filler layer only covers the central region of the transparent substrate, and a thickness of the transparent filler layer is equal to a thickness of the light-shielding layer.

6. The anti-scattering film according to claim 3, wherein, a protective layer is provided on a side of the transparent substrate away from the light-shielding layer, and a release film is provided on a side of the adhesive layer away from the transparent filler layer.

7. A touch screen comprising a touch panel, wherein, the touch panel is provided with the anti-scattering film according to claim 1.

8. The touch screen according to claim 7, wherein, the touch panel comprises a photoresist frame, and a projection of the light-shielding layer onto the transparent substrate is within a projection of the photoresist frame onto the transparent substrate.

9. The touch screen according to claim 8, wherein, the photoresist frame has the same pattern as the light-shielding layer.

10. The touch screen according to claim 8, wherein, the touch panel further comprises an alignment mark, and the alignment mark is formed of the same material and provided on the same layer as the photoresist frame.

11. A display device comprising the touch screen according to claim 7.

12. A manufacturing method of an anti-scattering film comprising steps of:
providing a transparent substrate; and
forming a light-shielding layer in a peripheral region of the transparent substrate.

13. The manufacturing method according to claim 12, wherein, after the step of forming the light-shielding layer in the peripheral region of the transparent substrate, the manufacturing method further comprises steps of:
forming a transparent filler layer on the transparent substrate, the transparent filler layer and the light-shielding layer being located on the same side of the transparent substrate; and
forming an adhesive layer on a side of the transparent filler layer away from the transparent substrate.

14. The manufacturing method according to claim 12, wherein, the light-shielding layer is formed of white ink or black ink.

15. A touch screen comprising a touch panel, wherein, the touch panel is provided with the anti-scattering film claim 2.

16. A touch screen comprising a touch panel, wherein, the touch panel is provided with the anti-scattering film claim 3.

17. A touch screen comprising a touch panel, wherein, the touch panel is provided with the anti-scattering film claim 4.

18. A touch screen comprising a touch panel, wherein, the touch panel is provided with the anti-scattering film claim 5.

19. A display device comprising the touch screen according to claim 8.

20. A display device comprising the touch screen according to claim 9.
